(19) United States
(12) Patent Application Publication
(10) Pub. No.: US 2024/0229566 A9
(43) Pub. Date: Jul. 11, 2024

(54) COUPLING FOR CONNECTING DOWNHOLE TUBULARS WITH IMPROVED STRESS DISTRIBUTION

(71) Applicant: SANDVIK MINING AND CONSTRUCTION TOOLS AB, Sandviken (SE)

(72) Inventors: Tomas JANSSON, Sandviken (SE); Anders NORDBERG, Sandviken (SE)

(21) Appl. No.: 18/278,768

(22) PCT Filed: Feb. 25, 2022
(86) PCT No.: PCT/EP2022/054823

§ 371 Date: Aug. 24, 2023

(30) Foreign Application Priority Data
Feb. 26, 2021 (EP) 21159696.0

(51) Int. Cl. E21B 17/042

(52) U.S. Cl. CPC E21B 17/0426

(57) ABSTRACT

A coupling for connecting downhole tubulars includes a tubular body, a female coupling part, a male coupling part, and at least one of: a male screw thread formed on an outer surface of the body, and a female screw thread formed in an inner surface of the body. The at least one thread has a thread-form including a crest, a root, and a pair of flanks. The crest and the root are each cambered about a respective first and second camber radius, R_{b}, R_{b}-T along the entire length of the thread-form, and each camber radius, R_{b}, R_{b}-T, is greater than an outer diameter of the coupling. The male screw thread has a camber radius, R_{bm}, and the female screw thread has a camber radius, R_{bf}, wherein the ratio of the male thread camber radius to the female thread camber radius (R_{bm}/R_{bf}) is between <1.0 and ≤1.1.

### FIELD OF INVENTION

The present disclosure generally relates to a cambered thread for a drill string coupling and in particular, although not exclusively, for a drill string utilized for percussive rock drilling.

### BACKGROUND

EP 1 511 911/U.S. Pat. No. 8,066,307 discloses a screw joint for a drill run or drill string for percussive rock drilling including male and female screw threads on the elements to be joined together to form a drill string, characterized in that the male thread and the female thread have a trapezoidal shape; that the threads have a conical inclination along the length of the threads with a cone angle smaller than 7 degrees, and in that the flank angles between the flanks of the threads and the line that is tangential with the apices of the threads is smaller than 45 degrees.

U.S. Pat. No. 4,121,862 discloses a tubular connection having a tapered pitch diameters at the entrance and exit of the thread. US2006/118340 discloses a screw joint having a trapezoidal shape and slight conical inclination.

The conical thread of the EP '911 patent is not optimal for distributing bending load evenly across the length thereof nor does the conical thread result in expedient coupling and uncoupling time. The wear resistance of the conical thread of the EP '911 patent leaves room for improvement. EP3536894 discloses a conical thread wherein the crest and the root of the thread are each cambered about a respective first and second camber radius along the entire length of the thread-form, and each camber radius is greater than an outer diameter of the coupling, which provides improved coupling characteristics and stiffness when subject to bending loads. However, there is a requirement to provide a coupling with a reduced level of stress, having the stress is more evenly distributed along the length of the thread, with no regions where there is a high stress concentration. Further, it is desirable to provide a coupling that wears more evenly along the length of the threaded coupling, has a reduced risk of premature breakage and increased the lifetime.

### SUMMARY OF THE INVENTION

The present disclosure generally relates to a cambered thread for a drill string coupling and in particular, although not exclusively, for a drill string utilized for percussive rock drilling. In one embodiment, a coupling for connecting downhole tubulars includes: a tubular body; a female coupling part; a male coupling part; and at least one of: a male screw thread formed on an outer surface of the body, and a female screw thread formed in an inner surface of the body. The at least one thread has a thread-form including a crest, a root, and a pair of flanks. The crest and the root are each cambered about a respective first and second camber radius. Each camber radius is greater than an outer diameter of the coupling. The male screw thread having a camber radius, R_{bm}, and the female screw thread having a camber radius, R_{bf}; characterized in that the ratio of the male thread camber radius to the female thread camber radius, R_{b}m/R_{bf} is >1.0 and ≤1.1, preferably between 1.01-1.05, more preferably between 1.01-1.03. In other words R_{bm} and R_{bf} should not be equal.

Advantageously, this provides a threaded coupling wherein the maximum stress is reduced along the length of the thread. Further, within this ratio the stress is most evenly distributed along the length of the thread and the presence of concentration peaks of high stress in localised regions are avoided. Consequently, the wear along the length of the thread occurs more evenly and so premature failures are less likely to happened and the lifetime of the parts are therefore increased.

Preferably, each camber radius (Rb, Rb-T) is between 700-1900 mm, preferably between 800-1700 mm, even more preferably between 900-1500 mm, even more preferably 1050-1400 mm, even more preferably 1100-1300 mm. Advantageously, this achieves the lowest possible average stress along the length of the thread. If the camber radius is too large, then the thread acts likes a straight thread and will therefore not have enough technical benefit over a straight thread. If the camber radius is too small the stresses will be hard to balance and will also increase the stresses as a result of this. Consequently, the wear along the length of the thread occurs more evenly due to an even distribution of contact pressure while bending so that premature failures are less likely.

In one aspect of the embodiment, each flank is straight, and each flank is connected to an adjacent crest and/or root by a respective arc.

In another aspect of the embodiment, a centerline of the thread-form perpendicular to an arc of each camber radius is inclined relative to a longitudinal axis of the coupling by an acute and nearly perpendicular first angle adjacent to a start of the at least one thread and inclined by a second angle adjacent to an end of the at least one thread, and the second angle is less than the first angle.

In another aspect of the embodiment, each camber radius is at least 5 times greater than an outer diameter of the coupling. In another aspect of the embodiment, the thread-form is asymmetric. In another aspect of the embodiment, the thread-form is trapezoidal. In another aspect of the embodiment, a sweep angle of the at least one thread ranges between one and 10 degrees. In another aspect of the embodiment, the root and the crest are concentric. In another aspect of the embodiment, an arc length of the root and an arc length of the crest are equal. In another aspect of the embodiment, an arc length of the root and an arc length of the crest are not equal.

In another aspect of the embodiment, a connection includes: a female coupling part having the female thread; and a male coupling part having the male thread and screwed into the female thread. One of the flanks is a contact flank and the other flank is a non-contact flank when the couplings are in compression. Each flank is straight. Each thread-form has a centerline perpendicular to an arc of each respective camber radius. Each flank has a flank angle inclined relative to the respective centerline. Each contact flank angle is greater than the respective non-contact flank angle.

Optionally, each non-contact flank angle is less than 45 degrees. Since the EP '911 patent defines flank angle as being measured from the thread apex, then the EP '911 teaching translates to flank angles being greater than 45 degrees. Minimizing the non-contact flank angle facilitates uncoupling and facilitates transmission of the shockwave during uncoupling.

In another aspect of the embodiment, each coupling is made from a metal or alloy. The male coupling part has an outer diameter portion, a reduced diameter portion having the male thread, and a shoulder connecting the two portions. The shoulder is engaged with an end of the female coupling part to form a metal to metal seal.

In another aspect of the embodiment, a drill rod for percussive drilling includes: a rod body; a female coupling part having the female thread and welded to a first end of the rod body; and a male coupling part having the male thread and welded to a second end of the rod body. Optionally, an outer diameter of the couplings ranges between 5 and 20 centimetres, and each camber radius is greater than one meter.

In another aspect of the embodiment, a drill string includes a drill rod.

### BRIEF DESCRIPTION OF DRAWINGS

A specific implementation of the present invention will now be described, by way of example only, and with reference to the accompanying drawings in which:

FIG. 1 illustrates a drill rod having a male coupling and a female coupling, each coupling including a cambered screw thread, according to one embodiment of the present disclosure;

FIG. 2A illustrates a cambered helix for designing the cambered threads. FIG. 2B illustrates parameters of the cambered threads;

FIGS. 3A-3G illustrate formulas for the cambered helix;

FIG. 4 illustrates the relationship of the male and female camber radii.

FIG. 5 illustrates a profile of the male cambered thread;

FIGS. 6A and 6B are enlargements of portions of FIG. 5;

FIG. 7 illustrates a profile of the female cambered thread;

FIGS. 8A and 8B are enlargements of portions of FIG. 7;

FIG. 9 illustrates the male and female couplings screwed together.

FIG. 10a-c show safety factor images captured using the Dang van criterion using rotating bending as the load case. FIG. 10a show the Dang van criterion when R_{bm}/R_{bf} is inside the preferred range while FIGS. 10b and 10c shows the Dang van criterion when R_{bm}/R_{bf} is above and below the preferred range respectively.

### DETAILED DESCRIPTION

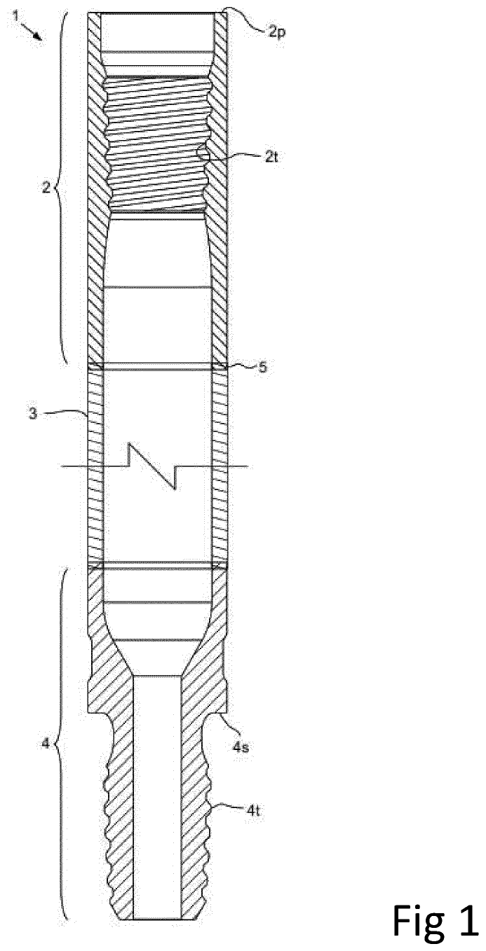

FIG. 1 illustrates a drill rod 1 having a female coupling 2 and a male coupling 4, each coupling including a respective cambered screw thread 2t, 4t, according to one embodiment of the present disclosure. The drill rod 1 may be made from a metal or alloy, such as steel. The drill rod 1 may also be case hardened, such as by carburization. Each coupling 2, 4 may be attached, such as welded 5, to an intermediate rod body 3 so as to form longitudinal ends of the drill rod 1. Each weld 5 may be seamless, such as a friction weld. The drill rod 1 may have a flow bore formed therethrough. The drill rod 1 may have a length of 6 meters.

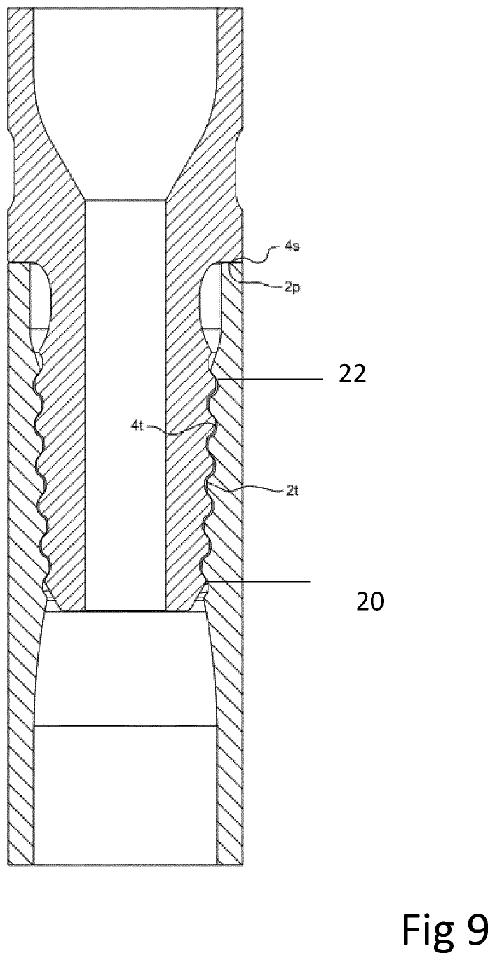

A drill string (not shown) may be formed by screwing together a plurality of drill rods 1 together (FIG. 9) along with a drill bit at one end and a shank adapter at the other end. The drill bit and shank adapter may also have either of the cambered screw threads 2t, 4t. The drill string may be used for percussive rock drilling with a top hammer (not shown) or downhole hammer (not shown). If a downhole hammer is used, the hammer may have each of the cambered screw threads 2t, 4t for assembly as part of the drill string.

Alternatively, the drill rod 1 may have a pair of male couplings 4 and a sleeve (not shown) having a pair of female couplings 2 may be used to connect a pair of drill rods together. Alternatively, the cambered screw threads 2t, 4t may be used to connect other types of downhole tubulars, such as oilfield drill pipe, oilfield casing or liner, oilfield production tubing, or oilfield sucker rod.

The male coupling part 4 may have a tubular body with an outer diameter upper portion for connection to a lower end of the rod body 3, a reduced diameter lower portion having the external male thread 4t formed in an outer surface thereof, and a shoulder 4s connecting the upper and lower portions. The upper portion of the male coupling part may have a plurality of wrench flats formed in an outer surface thereof. The flow bore in the upper portion may include a nozzle and a portion of a throat. The throat may extend through the shoulder 4s and the lower portion.

The female coupling part 2 may have a tubular body with a lower portion for connection to an upper end of the rod body 3. The female coupling part 2 may have the internal female thread 2t formed in an inner surface thereof adjacent to the flow bore thereof. The flow bore may be sized to receive the reduced diameter lower portion of the male coupling part 4 of another drill rod (FIG. 9). The male coupling part 4 may be screwed into the female coupling part 2 until the shoulder 4s abuts a top 2p of the female coupling, thereby creating a metal-to-metal seal for isolating the flow bore and fastening the two drill rods together. The flow bore of the female coupling part 2 may include a diffuser located adjacent to a lower end of the female thread 2t.

Alternatively, the male coupling part 4 may be connected to an upper end of the rod body 3 and the female coupling part 2 may be connected to a lower end of the rod body. In this alternative, the nozzle of the male coupling part 4 would be a diffuser and the diffuser of the female coupling part 2 would be a nozzle.

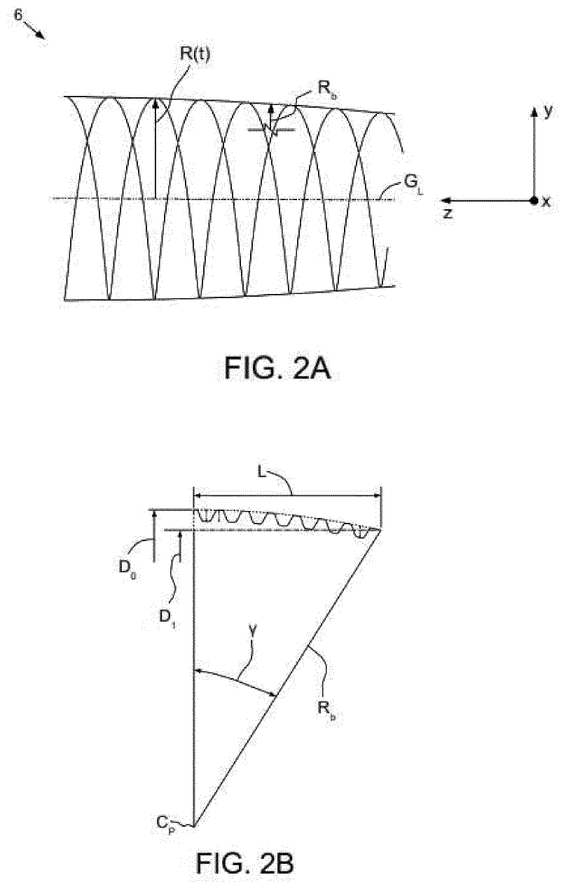

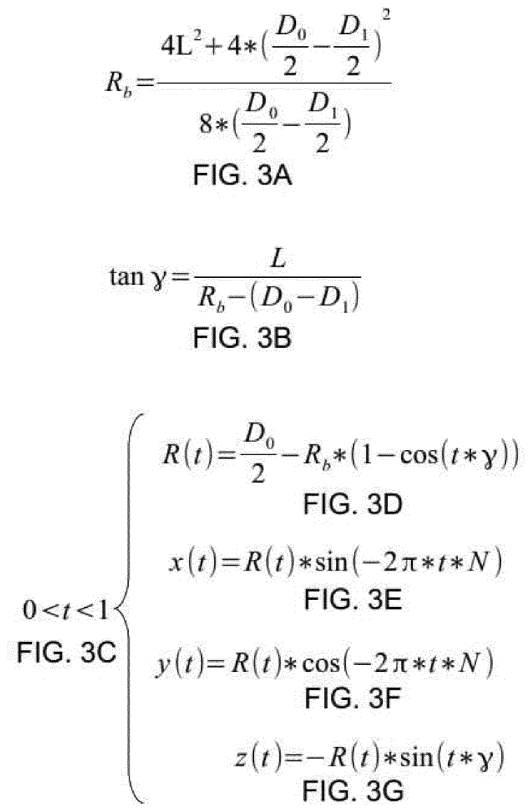

FIG. 2A illustrates a cambered helix 6 for designing the cambered threads 2t, 4t. FIG. 2B illustrates parameters of the cambered threads 2t, 4t. FIGS. 3A-3H illustrate formulas for the cambered helix 6. To design the cambered threads 2t, 4t, one or more thread parameters, such as a start diameter D₀, an end diameter D₁, and a (linear) length L, may be specified utilizing dimensions of the drill rod 1. Once the thread parameters have been specified, a camber radius R_{b} may be calculated utilizing the formula of FIG. 3A. The camber radius R_{b} may extend from a CenterPoint C_{P} and may define crests of the male thread 4t and roots of the female thread 2t. The thread parameters may be specified such that the camber radius R_{b} is greater than, such as 5 or 10 times greater than, an outer diameter of the coupling parts 2, 4. The outer diameter of the coupling parts 2, 4 may range between 5 and 20 centimeters and the camber radius R_{b} may be greater than one meter, such as ranging between 1.05 meters and 1.7 meters.

Once the camber radius R_{b} has been calculated, a sweep angle γ may be calculated utilizing the formula of FIG. 3B. The sweep angle γ may range between one and ten degrees. Once the sweep angle γ has been calculated, the cambered helix 6 may be generated using the parametric formulas of FIGS. 3C-3G. The cambered helix 6 may be used to define an outline of the cambered threads 2t, 4t. In the parametric formulas, R(t) may be a radial coordinate of the cambered helix about a longitudinal axis G_{L} of the drill rod 1. The convention of the formulas of FIGS. 3E-3G may be negative (shown) for a left-handed thread and positive for a right-handed thread.

The female 2t and male 4t threads may be complementary such that the male thread of one drill rod 1 may be screwed into the female thread of another drill rod (FIG. 9). To facilitate screwing and unscrewing of the threads 2t, 4t, the male 4t and female 2t threads may be similar but not be identical mirror images of each other. The above discussed design process may be performed once for the female thread 2t and again for the male thread 4t. Each of the female 2t and male 4t threads may be double threads.

To avoid stress concentrations in localised regions of the thread the ratio of the camber radius on the male thread R_{bm} to the camber radius on the female thread R_{bf} should be >1.0 and ≤1.1, preferably between 1.01 and 1.05, even more preferably between 1.01-1.03.

In other words, R_{bm}/R_{bf}=>1.0-1.1, preferably 1.01-1.05, more preferably 1.01-1.03.

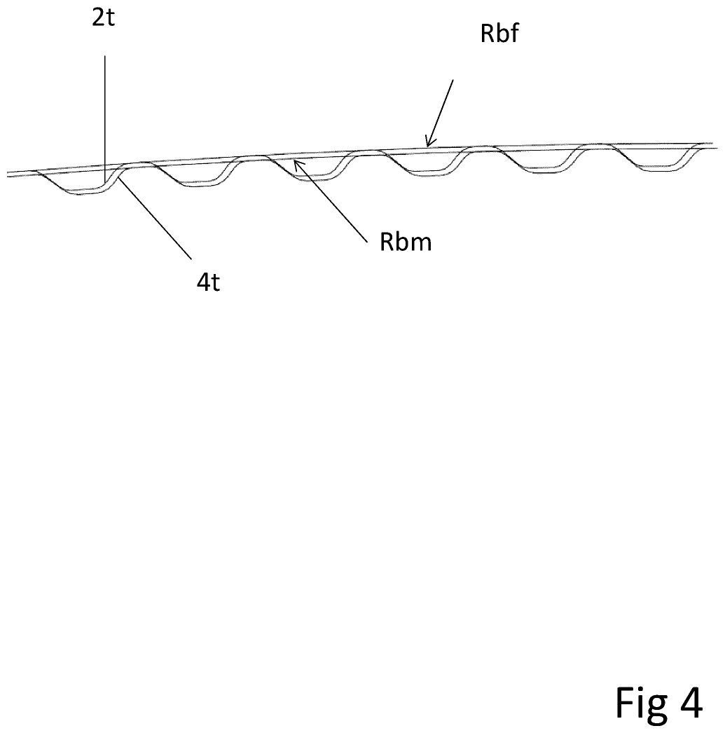

FIG. 4 illustrates an example when the ratio of the male and female camber radii is within the preferred range.

If the ratio is below 1.0, then a high concentration of stress in the region of a first male thread 20 will be present. This is a problem because all the loads will be located in only the start of the thread causing high stress concentrations and likely a lower tool life and increase risk of sudden breakages. If the ratio is above 1.1, then a high concentration of stress in the region of the endmost male thread 22 will be present. This is a problem because all the load will be applied to the endmost thread among the threads and causing higher stress concentrations and thus reducing tool life and the risk of sudden breakages. If the ratio is swapped around, such that the camber radius on the female thread is larger than the camber radius on the male thread, this has an adverse effect on the stress. The preferred ranges relate to ratio ranges where the lowest possible, most evenly distributed stress is achieved.

Preferably, each camber radius (R_{b}, R_{b}-T) is between 700-1900 mm, preferably between 800-1700 mm, even more preferably between 900-1500 mm, even more preferably 1050-1400 mm, even more preferably 1100-1300 mm.

Alternatively, the cambered threads 2t, 4t may be right-handed threads. Alternatively, each of the female 2t and male 4t threads may be a single thread or triple threads.

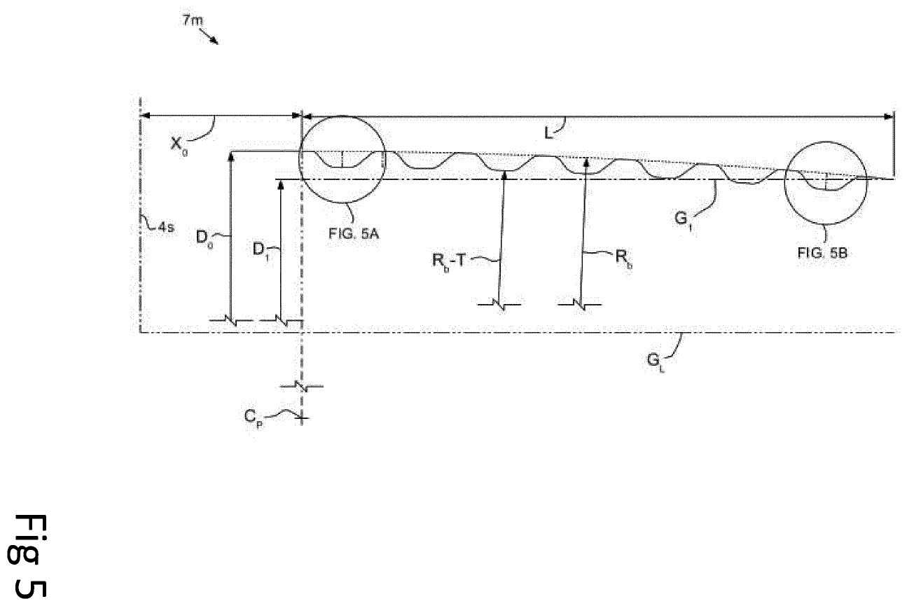

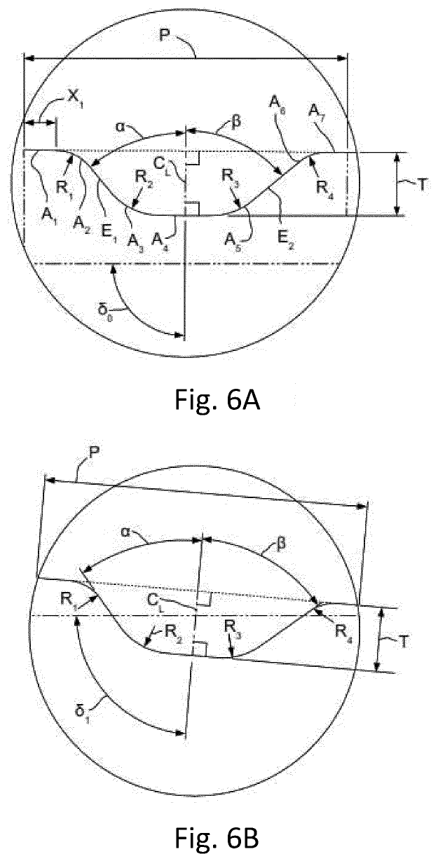

FIG. 5 illustrates a profile 7m of the male cambered thread 4t. FIGS. 6A and 6B are enlargements of portions of FIG. 5. Once the outline of the male thread 4t has been generated, the profile 7m may be determined. The profile 7m may start at a standoff distance X₀ from the shoulder 4s. The profile 7m may end at a point where the crest of the profile intersects an axis G₁ parallel to the longitudinal axis G_{L} and offset to the end diameter D₁. The sweep angle γ may define the arcuate extent of the profile 7m from start to end and may range between one and 10 degrees.

Referring specifically to FIG. 6A, a thread-form of the profile 7m may include a first crest A₁. The thread-form may have a trapezoidal shape. The first crest A₁ may be an arc with the (outer) camber radius R_{b} and may extend to a second arc A₂. The centerline C_{L} may be inclined relative to the offset axis G₁ at an acute and nearly perpendicular first angle δ₀. The second arc A₂ may have a radius less than one percent of the outer camber radius R_{b}. The second arc A₂ may extend from the first crest A₁ to a non-contact flank E₁. The second arc A₂ may be tangential to the first crest A₁ and the non-contact flank E₁.

The non-contact flank E₁ may be a straight line inclined at a first flank angle α relative to the centerline C_{L}. The first flank angle α may range between 35 and 55 degrees or the first flank angle may be less than 45 degrees. The non-contact flank E₁ may extend from the 10 second arc A₂ to a third arc A₃. The third arc A₃ may have a radius less than one percent of the outer camber radius R_{b}. The third arc A₃ may extend from the non-contact flank E₁ to a first root A₄. The third arc A₃ may be tangential to the non-contact flank E₁ and the first root A₄. The thread-form may have a height T between the first root A₄ and a second crest A₇. The first root A₄ may be an arc with an inner camber radius R_{b}-T and may extend from the third arc A₃ to a fifth arc A₅. The height T may be less than one percent of the outer camber radius R_{b} such that the inner camber radius R_{b}-T is also greater than the outer diameter of the male coupling part 4, as discussed above for the camber radius. The first root A₄ may be concentric with the first crest A₁. The centerline C_{L} may be perpendicular to an arc of each camber radius R_{b}, R_{b}-T.

The fifth arc A₅ may have a radius less than one percent of the camber radius R_{b}. The fifth arc A₅ may extend from the first root A₄ to a contact flank E₂. The fifth arc A₅ may be tangential to the first root A₄ and the contact flank E₂. The contact flank E₂ may be a straight line inclined at a second flank angle R relative to the centerline C_{L}. The second flank angle R may range between 40 and 45 degrees. The first flank angle α may be less than the second flank angle β, thereby resulting in an asymmetric thread-form. The contact flank E₂ may extend from the fifth arc A₅ to a sixth arc A₆. The sixth arc A₆ may extend from the contact flank E₂ to the second crest A₇. The sixth arc A₆ may be tangential to the contact flank E₂ and the second crest A₇. The second crest A₇ may be an arc with the outer camber radius R_{b}.

The thread-form may have an (arc length) pitch P between a start of the profile 7m and a center of the second crest A₇. The first crest A₁ may have an arc length X₁ which may also be equal to one-half the arc-length of the second crest A₇. The first root A₄ may also have an arc length equal to twice that of the arc length X₁.

Alternatively, the crests and roots may have different arc lengths. Alternatively, the second flank angle may be less than 45 degrees.

Referring specifically to FIG. 6B, due to the camber of the profile 7m about each camber radius R_{b}, R_{b}-T, the centerline C_{L} of the thread-form adjacent to the end of the profile 7m may be inclined relative to the offset axis G₁ at a second acute angle δ₁ which is less than the first angle δ₀.

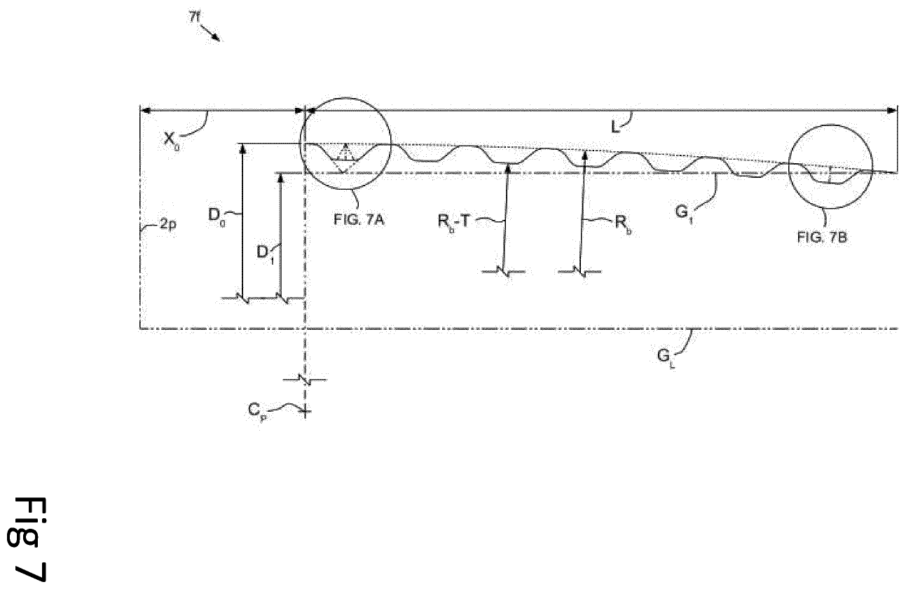

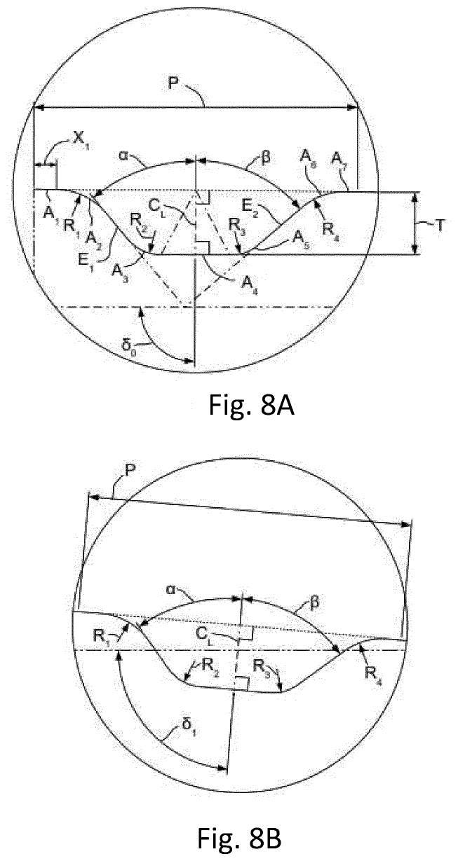

FIG. 7 illustrates a profile 8f of the female cambered thread 2t. FIGS. 8A and 8B are enlargements of portions of FIG. 7. Once the outline of the female thread 2t has been generated, the profile 7f may be determined. The profile 7f may start at a standoff distance X₀ from the top 2p. The profile 7f may end at a point where the root of the profile intersects an axis G₁ parallel to the longitudinal axis G_{L} and offset to the end diameter D₁. The standoff distance X₀ of the female profile 7f may differ slightly from the standoff distance of the male profile 7m. The sweep angle γ may define the arcuate extent of the profile 7f from start to end and may range between one and 10 degrees.

Referring specifically to FIG. 8A, a thread-form of the profile 7f may include a first root A₁. The thread-form may have a trapezoidal shape. The first root A₁ may be an arc with the outer camber radius R_{b} and may extend to a second arc A₂. The outer camber radius R_{b} of the female profile 7f may differ slightly from the outer camber radius of the male profile 7m. The centerline C_{L} may be inclined relative to the offset axis G₁ at an acute and nearly perpendicular first angle δ₀. The second arc A₂ may have a radius less than one percent of the outer camber radius R_{b}. The second arc A₂ may extend from the first root A₁ to a non-contact flank E₁. The second arc A₂ may be tangential to the first root A₁ and the non-contact flank E₁. The non-contact flank E₁ may be a straight line inclined at a first flank angle α relative to the centerline C_{L}. The first flank angle α may range between 35 and 55 degrees.

The non-contact flank E₁ may extend from the second arc A₂ to a third arc A₃. The third arc A₃ may have a radius less than one percent of the outer camber radius R_{b}. The third arc A₃ may extend from the non-contact flank E₁ to a first crest A₄. The third arc A₃ may be tangential to the non-contact flank E₁ and the first crest A₄. The thread-form may have a height T between the first crest A₄ and a second root A₇. The first crest A₄ may be an arc with an inner camber radius R_{b}-T and may extend from the third arc A₃ to a fifth arc A₅. The inner camber radius R_{b}-T of the female profile 7f may differ slightly from the inner camber radius of the male profile 7m. As shown by the pair of phantom lines extending from endpoints of the first crest A₄, the centerline C_{L} may extend through a midpoint of the first crest A₄. The centerline C_{L} may be perpendicular to an arc of each camber radius R_{b}, R_{b}-T. The height T may be less than one percent of the outer camber radius R_{b} such that the inner camber radius R_{b}-T is also greater than the outer diameter of the female coupling 2 as discussed above for the camber radius.

The fifth arc A₅ may have a radius less than one percent of the outer camber radius R_{b}. The fifth arc A₅ may extend from the first crest A₄ to a contact flank E₂. The fifth arc A₅ may be tangential to the first crest A₄ and the contact flank E₂. The contact flank E2 may be a straight line inclined at a second flank angle R relative to the centerline C_{L}. The second flank angle R may range between 40 and 45 degrees. The first flank angle α may be less than the second flank angle β, thereby resulting in an asymmetric thread-form. The asymmetric thread-form is further illustrated by projections of the flanks E₁, E₂ intersecting at a point offset from the centerline C_{L}. The second flank angle R of the female profile 7f may differ slightly from the second flank angle of the male profile 7m. The contact flank E₂ may extend from the fifth arc A₅ to a sixth arc A₆. The sixth arc A₆ may extend from the contact flank E₂ to the second root A₇. The sixth arc A₆ may be tangential to the contact flank E₂ and the second root A₇. The second root A₇ may be an arc with the outer camber radius R_{b}.

The thread-form may have an (arc length) pitch P between a start of the profile 7m and a center of the second root A₇. The first root A₁ may have an arc length X₁ which may also be equal to one-half the arc-length of the second root A₇. The arc length X₁ of the female profile 7f may differ from the arc length of the male profile 7m. The first crest A₄ may also have an arc length less than twice that of the arc length X₁.

Alternatively, the roots and crests may have the same arc lengths.

Referring specifically to FIG. 8B, due to the camber of the profile 7m about each camber radius R_{b}, R_{b}-T, the centerline C_{L} of the thread-form adjacent to the end of the profile 7m may be inclined relative to the offset axis G₁ at a second acute angle δ₁ which is less than the first angle δ₀.

Reference to the contact flanks E₂ and the non-contact flanks E₁ is for the context of drilling when the drill string is in compression. When tripping the drill string from the drilled hole and unscrewing the drill rods, the drill string is in tension and the contact flanks E₂ become the non-contact flanks and the non-contact flanks E₁ become the contact flanks, as shown in FIG. 9.

FIG. 9 illustrates the male 4 and female 2 coupling parts screwed together. Once the thread profiles 7m,f have been generated, each profile may be adapted to create the geometry of the respective cambered thread 4t, 2t, such as by truncation thereof. The cambered curvature of each thread 2t, 4t along the longitudinal axis G_{L} may result in an frusto-ogive shape.

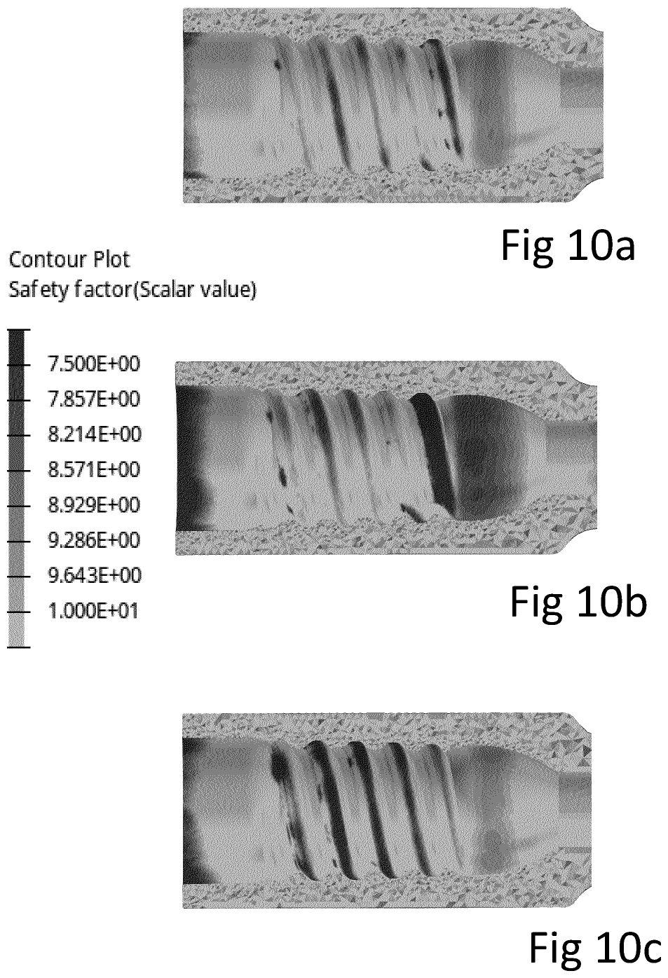

FIG. 10a-c show safety factor images captured using the Dang van criterion with rotating bending as the load case for couplings having different ratios between the camber radius of the male thread R_{bm} and the female thread R_{b}f, as described in Table 1 below:

TABLE 1
Dang van values

| FIG. | R_{bm} | R_{bf} | R_{bm}:R_{bf} Ratio | Dang van |
|---|---|---|---|---|
| 10a (invention) | 1290 | 1265 | 1.020 | 7.45 |
| 10b (comparison) | 1151 | 1110 | 1.037 | 5.5 |
| 10c (comparison) | 1290 | 1305 | 0.989 | 6.1 |

The images were captured using the Dang van criterion. Using implicit analysis in LS-Dyna the Dang van criterion is extracted using the nCode software. The risk for failure is increased as the value of the Dang van criterion in decreased. Thus, darker colours mean higher risk for failure. It can be seen that when R_{bm}/R_{bf} is within the preferred range the risk of failure is decreased compared to when R_{bm}/R_{b}f is above or below the preferred range and in addition the risk of failure is more evenly distributed.

1. A coupling for connecting downhole tubulars, comprising:
a tubular body;
a female coupling part;
a male coupling part; and
at least one of:
a male screw thread formed on an outer surface of the body, and
a female screw thread formed in an inner surface of the body, wherein the at least one thread has a thread-form including a crest, a root, and a pair of flanks, wherein the crest and the root are each cambered about a respective first and second camber radius along the entire length of the thread-form, and wherein the male screw thread has a camber radius and the female screw thread has a camber radius, the ratio of the male thread camber radius to the female thread camber radius (R_{bm}/R_{bf}) being >1.0 and ≤1.1.

2. The coupling according to claim 1, wherein R_{bm}/R_{bf} is between 1.01 and 1.05.

3. The coupling according claim 1, wherein each first and second camber radius is between 700-1900 mm.

4. The coupling according to any preceding claim, wherein each flank of the pair of flanks is straight, and each flank is connected to an adjacent crest and/or root by a respective arc.

5. The coupling according to claim 1, wherein a centerline of the thread-form is perpendicular to an arc of each first and second camber radius and is inclined relative to a longitudinal axis of the coupling by an acute and nearly perpendicular first angle adjacent to a start of the at least one thread and inclined by a second angle adjacent to an end of the at least one thread, and the second angle is less than the first angle.

6. The coupling according to claim 1, wherein each first and second camber radius (R_{b}, R_{b}-T) is at least 5 times greater than an outer diameter of the coupling.

7. The coupling according to claim 1, wherein the thread-form is asymmetric.

8. The coupling according to claim 1, wherein the thread-form is trapezoidal.

9. The coupling according to claim 1, wherein a sweep angle of the at least one thread ranges between one and 10 degrees.

10. The coupling according to claim 1, wherein the root and the crest are concentric.

11. The coupling according to claim 1, wherein an arc length of the root and an arc length of the crest are equal.

12. The coupling according to claim 1, wherein an arc length of the root and an arc length of the crest are not equal.

13. A connection, comprising:
a coupling according to claim 1, the coupling including the female coupling part having the female thread, and the male coupling part having the male thread, and which is screwed into the female thread, wherein one of the flanks is a contact flank and the other flank is a non-contact flank when the female and male coupling parts are in compression, wherein each flank is straight, each thread-form has a centerline perpendicular to an arc of each respective camber radius, each flank has a flank angle inclined relative to the respective centerline, and each contact flank angle is greater than the respective non-contact flank angle.

14. The connection according to claim 13, wherein each non-contact flank angle is less than 45 degrees.

15. The connection according to claim 14, wherein each coupling is made from a metal or alloy, the male coupling part has an outer diameter portion, a reduced diameter portion having the male thread, and a shoulder connecting the two portions, and the shoulder is engaged with an end of the female coupling part to form a metal to metal seal.

16. A drill rod for percussive drilling, comprising:
a rod body;
a coupling according to claim 1, the coupling including the female coupling part having the female thread and, which is welded to a first end of the rod body, and the male coupling part having the male thread and, which is welded to a second end of the rod body.

17. The drill rod according to claim 16, wherein an outer diameter of the female and male couplings ranges between 5 and 20 centimeters, and wherein each camber radius is greater than one meter.

18. A drill string comprising a drill rod according to claim 16.
